(19) United States
(12) Patent Application Publication
(10) Pub. No.: US 2020/0255771 A1
(43) Pub. Date: Aug. 13, 2020

(54) METHOD OF TREATING FABRICS WITH AUTOMATED PRE-TREATMENT OF WATER

(71) Applicant: The Procter & Gamble Company, Cincinnati, OH (US)

(72) Inventors: Anju Deepali Massey BROOKER, Newcastle Upon Tyne (GB); Carlos AMADOR ZAMARRENO, Newcastle Upon Tyne (GB); Laura BUENO ROMO, Newcastle Upon Tyne (GB); Philip Frank SOUTER, Newcastle Upon Tyne (GB); Andrew John SMITH, Newcastle Upon Tyne (GB)

(21) Appl. No.: 16/783,198

(22) Filed: Feb. 6, 2020

(30) Foreign Application Priority Data
Feb. 8, 2019 (EP) 19156125.7

(51) Int. Cl. C11D 3/36; D06F 33/57; C11D 1/22; C11D 1/14; C11D 3/20

(52) U.S. Cl. CPC C11D 3/364; D06F 33/57; C11D 3/361; C11D 3/2065; C11D 1/143; C11D 3/2082; C11D 1/22

(57) ABSTRACT

The present invention relates to a method for treating fabrics by using an automatic laundry washing machine, in which unwetted fabrics are contacted with water that has been automatically pre-treated with a pre-treatment composition comprising at least one chelant before the wash cycle starts.

### FIELD OF THE INVENTION

This method relates to a method of treating fabrics using an automatic laundry washing machine.

### BACKGROUND OF THE INVENTION

Satisfactory removal of certain tough stains from fabrics, such as tea stains, wine stains, coffee stains, body soil or makeup stains, has been a challenge for formulators of laundry detergents. This challenge is particularly exacerbated when automatic laundry washing machine is used for the fabric treatment, because unlike in the hand-washing setting where the consumers can apply additional mechanical or physical force to specifically target these tough stains, the automatic machine-washing setting does not allow such targeted application of mechanical or physical force. Consequently, the burden to remove these tough stains falls heavily upon the laundry detergent compositions.

Although it is possible to include more detersive actives into the laundry detergent composition to improve the stain removal performance against these tough stains, such additives will inevitably increase the manufacturing costs and processing complexity associated with the laundry detergents. Further, such additives (e.g., bleach additives) may have a negative impact on the structural integrity of fabrics being treated and may also lead to a greater environmental footprint.

Therefore, there is a need to provide a method of treating fabrics, especially fabrics containing tough stains as mentioned hereinabove, with improved stain removal performance but without the need for any new additives.

### SUMMARY OF THE INVENTION

It has been discovered by the present invention that by configuring the automatic laundry washing machine to automatically pre-treat the full volume of water (or a substantial portion thereof) that comes into the machine with a pre-treatment composition containing chelants before the fabrics are contacted with and wetted by any water, the stain removal performance may significantly improve, especially against tough stains such as tea stains, wine stains, and coffee stains. Specifically, the chelants can effectively sequestrate heavy metal ions in the water before the water comes into contact with such tough stains and makes these stains more difficult to remove. Further, the chelants used in such pre-treatment composition are ingredients already existing in most laundry detergent compositions in market today, so no new or special detersive actives are needed. Instead, by configuring the automatic laundry washing machine to conduct a simple water pre-treatment step with the chelants before the fabrics are wetted, the tough stains can be more effectively removed without increasing the manufacturing costs and processing complexity associated with the laundry detergent compositions.

Additionally, pre-treatment of water with the chelants and optionally other detersive actives provides additional benefits that may accelerate the kinetics of cleaning. For example, since the detersive chemistry is pre-dissolved in water, no additional time is needed to dissolve the chemistry inside the washing machine. Further, the risk of fabrics directly absorbing un-dissolved liquid detergent and thereby reducing its dissolution rate is significantly reduced. The detersive chemistry actives reach the surface of fabrics instantaneously by convective capillarity, versus dissolving the detersive chemistry in the water that is outside of the fabrics (which may require about 2-10 minutes for the concentration of detersive chemistry in the water outside of the fabrics to equalize the concentration of detersive chemistry in the water inside the fabrics). Consequently, significantly improved cleaning benefit is observed with little or no change to the final composition of the detersive chemistry.

In one aspect, the present invention provides a method of treating fabrics using an automatic laundry washing machine, comprising the steps of:
a) Providing a pre-treatment composition comprising at least one chelant and an automatic laundry washing machine capable of automatically pre-treating water with said pre-treatment composition;
b) Operating said automatic laundry washing machine to automatically pre-treat water with said pre-treatment composition;
c) Subsequently, contacting unwetted fabrics with a sufficient amount of the pre-treated water in said automatic laundry washing machine to substantially wet said fabrics; and
d) Subsequently, treating the wetted fabrics in said automatic laundry washing machine.

In addition to the at least one chelant, said pre-treatment composition may further comprise at least one builder.

In a specific embodiment of the present invention, the pre-treatment composition is essentially free of any detersive surfactants, while a fabric treatment composition comprising at least one detersive surfactant is subsequently added into the aqueous wash liquor after step (c) for treatment of the wetted fabrics. In an alternative embodiment of the present invention, the pre-treatment composition may further comprise at least one detersive surfactant.

Preferably, the fabrics to be treated comprise one or more stains selected from the group consisting of tea stains, wine stains, coffee stains, body soils, greasy stains, and any combinations thereof. More preferably, said fabrics to be treated comprise one or more tea stains and/or wine stains.

This and other aspects of the present invention will become more apparent upon reading the following detailed description of the invention.

### BRIEF DESCRIPTION OF DRAWINGS

FIG. 1 is a schematic diagram of a stain before and after wash.

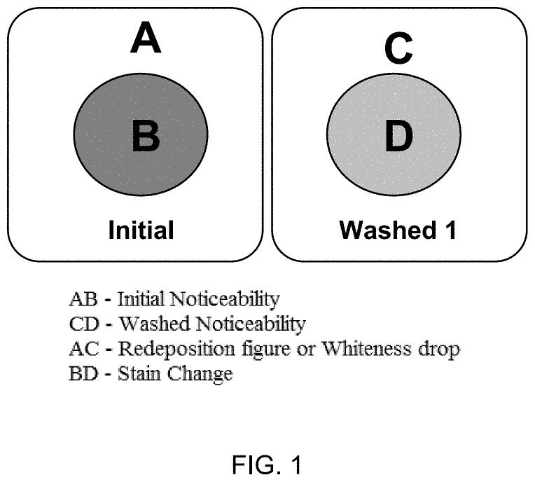

### DETAILED DESCRIPTION OF THE INVENTION

As used herein, articles such as “a” and “an” when used in a claim, are understood to mean one or more of what is claimed or described. The terms “comprise,” “comprises,” “comprising,” “contain,” “contains,” “containing,” “include,” “includes” and “including” are all meant to be non-limiting.

As used herein, the term “Saturation” is referring to a parameter indicative of certain fabrics' ability to absorb and hold water when wetted. Saturation of specific fabrics is determined as follows:
First, the weight of the dry fabrics is measured;
Soak the fabrics in water for about 15 minutes;
Then take the soaked fabrics out of water and hang them spread out for about 20 seconds in ambient conditions;
Measure the weight of the wet fabrics;
Determine the saturation water weight in the wet fabrics, as follows:

Saturation Water Weight=Wet Fabrics Weight−Dry Fabrics Weight;
Calculate Saturation as follows:

Saturation=Saturation Water Weight/Dry Fabrics Weight

Once the Saturation parameter of a specific type of fabrics has been determined, the Saturation Water Weight needed for a ballast made of such fabrics to become saturated with water can be easily calculated as Total Ballast Weight x Saturation.

As used herein, the term “unwetted fabrics” refers to fabrics that contain less than about 5% of the Saturation Water Weight, preferably less than about 3% of the Saturation Water Weight, more preferably less than about 1% of the Saturation Water Weight, and most preferably said fabrics are dry with no detectable water content.

As used herein, the term “wetted fabrics” or “substantially wetted fabrics” refers to fabrics that contain more than about 80% of the Saturation Water Weight, preferably more than about 90% of the Saturation Water Weight, and most preferably about 100% of the Saturation Water Weight, i.e., such fabrics are saturated with water.

As used herein, the term “partially wetted fabrics” refers to fabrics that contains from about 5% to about 80% of its Saturation Water Weight.

As used herein, the term “essentially free of” or “essentially free from” means that the indicated material is at the very minimum not deliberately added to the composition to form part of it, or, preferably, is not present at analytically detectable levels. It is meant to include compositions whereby the indicated material is present only as an impurity in one of the other materials deliberately included.

As used herein, all concentrations and ratios are on a weight basis unless otherwise specified. All temperatures herein are in degrees Celsius (° C.) unless otherwise indicated. All conditions herein are at 20° C. and under the atmospheric pressure, unless otherwise specifically stated.

The use of chelants in laundry detergent compositions is generally desirable for sequestrating metal ions in the water and preventing such metal ions from reacting with stains on the fabrics to form hard-to-remove reaction products. However, it is a surprising and unexpected discovery of the present invention that by automatically pre-treating the full volume of water that comes into the automatic washing machine with a treatment composition that contains chelants, stain removal can be significantly enhanced, particularly removal of polyphenolic stains such as tea and wine stains. Without being bound by any theory, it is believed that the catechin flavonoids in the tea or wine stains contain catechol units that may bond irreversibly with metal ions in the water (especially Fe ions) and render such stains difficult to be removed during the wash cycle. Correspondingly, the pre-treatment of water with chelants before any of such water comes in contact with the fabrics, i.e., before the metal ions in the water have the opportunity to bond with catechins in the tea or wine stains and make such stains difficult to remove, is important for the practice of the present invention.

The chelants to be used for water pre-treatment in the present invention may include any chelants that can bind common metal ions in water, such as Fe³⁺, Cu²⁺, Ca²⁺, Mg²⁺, and the like. Preferably, such chelants are characterized by a sufficiently high binding affinity for Fe³⁺ ions, e.g., having a Fe³⁺ binding constant of no less than about 10, preferably no less than about 11, more preferably no less than about 15, most preferably no less than about 20.

Examples of suitable chelants for the practice of the present invention may be selected from the group consisting of hydroxyethylidene diphosphonic acid (HEDP) and salts thereof, diethylene triamine penta(methylenephosphonic) acid (DTPMP) and salts thereof, ethylene diamine tetra(methylenephosphonic) acid (DDTMP) and salts thereof, amino tris(methylenephosphonic) acid (ATMP) and salts thereof, nitrilo tetra(methylenephosphonic) acid (NTMP) and salts thereof, ethylene diamine tetra(methylenephosphonic) acid (EDTMP) and salts thereof, tetraethylene diamine tetra(methylenephosphonic) acid (TDTMP) and salts thereof, hexamethylene diamine tetra(methylenephosphonic) acid (HDTMP) and salts thereof, diethylene triamine pentaacetic acid (DTPA) and salts thereof, ethylene diamine tetraacetic acid (EDTA) and salts thereof, hydroxyethylethylene diamine triacetic acid (HEDTA) and salts thereof, ethylene diamine disuccinic acid (EDDS) and salts thereof, disulfonated catechol, methylglycine diacetic acid (MGDA) and salts thereof, hydroxyiminodisuccinic acid (HIDS) and salts thereof, L-glutamic acid N,N-diacetic acid (GLDA) and salts thereof, and any combinations thereof.

Preferably, the pre-treatment composition of the present invention comprises at least one chelant selected from the group consisting of HEDP, DTPMP and/or salts thereof. More preferably, the pre-treatment composition of the present invention comprises HEDP (or a salt thereof) and DTPMP (or a salt thereof) at a weight ratio ranging from about 1:5 to about 5:1, preferably from about 1:3 to about 3:1, more preferably from about 1:2 to about 2:1, most preferably from about 1:1.2 to about 1.2:1.

In addition to the chelant(s), the pre-treatment composition of the present invention may further comprise at least one builder. Preferably, said at least one builder is one typically used in the laundry detergent compositions. Examples of suitable builders for practice of the present invention include fatty acids and salts thereof, citric acid and salts thereof, boric acid and salts thereof, zeolite, and any combinations thereof. Preferably, the pre-treatment composition of the present invention comprises at least one builder selected from the group consisting of fatty acids and salts thereof, citric acid and salts thereof, and any combinations thereof. More preferably, the pre-treatment composition of the present invention comprises fatty acids (or salts thereof) and citric acid (or a salt thereof) at a weight ratio ranging from about 1:5 to about 5:1, preferably from about 1:3 to about 3:1, more preferably from about 1:2 to about 2:1.

In a specific embodiment of the present invention, the pre-treatment composition is separate from the laundry detergent composition used for treating the fabrics. In other words, a fabric treatment composition is added to the wetted fabrics after step (c), either before or during step (d), for subsequent treatment of the fabrics. Correspondingly, the pre-treatment composition is essentially free of any detersive surfactants, and wherein a fabric treatment composition comprising at least one detersive surfactant is subsequently added into the aqueous wash liquor after step (c) for treatment of the wetted fabrics. Preferably, said at least one detersive surfactant comprises an anionic surfactant and a nonionic surfactant.

In an alternative embodiment of the present invention, the pre-treatment composition is the same as the laundry detergent composition used for treating the fabrics during the wash cycle of the automatic machine-washing process. In other words, the laundry detergent composition is first used to pre-treat the full volume of water that comes into the washing machine to form the washing liquor, before the unwetted fabrics is contacted with any water and before the washing cycle starts. Correspondingly, such a pre-treatment composition further comprises one or more detersive surfactants, preferably an anionic surfactant and a nonionic surfactant.

Useful anionic surfactants for the practice of the present invention can themselves be of several different types. For example, water-soluble salts of the higher fatty acids, i.e., “soaps”, are useful anionic surfactants. This includes alkali metal soaps such as the sodium, potassium, ammonium, and alkyl ammonium salts of higher fatty acids containing from about 8 to about 24 carbon atoms, and preferably from about 12 to about 18 carbon atoms. Soaps can be made by direct saponification of fats and oils or by the neutralization of free fatty acids. Particularly useful are the sodium and potassium salts of the mixtures of fatty acids derived from coconut oil and tallow, i.e., sodium or potassium tallow and coconut soap. Additional non-soap anionic surfactants which are suitable for use herein include the water-soluble salts, preferably the alkali metal, and ammonium salts, of organic sulfuric reaction products having in their molecular structure an alkyl group (included in the term “alkyl” is the alkyl portion of acyl groups) containing from about 10 to about 20 carbon atoms and a sulfonic acid or sulfuric acid ester group. Examples of this group of synthetic anionic surfactants include, but are not limited to: a) the sodium, potassium and ammonium alkyl sulfates with either linear or branched carbon chains, especially those obtained by sulfating the higher alcohols (C₁₀-C₂₀ carbon atoms), such as those produced by reducing the glycerides of tallow or coconut oil; b) the sodium, potassium and ammonium alkylethoxy sulfates with either linear or branched carbon chains, particularly those in which the alkyl group contains from about 10 to about 20, preferably from about 12 to about 18 carbon atoms, and wherein the ethoxylated chain has, in average, a degree of ethoxylation ranging from about 0.1 to about 5, preferably from about 0.3 to about 4, and more preferably from about 0.5 to about 3; c) the sodium and potassium alkyl benzene sulfonates in which the alkyl group contains from about 10 to about 20 carbon atoms in either a linear or a branched carbon chain configuration, preferably a linear carbon chain configuration; d) the sodium, potassium and ammonium alkyl sulphonates in which the alkyl group contains from about 10 to about 20 carbon atoms in either a linear or a branched configuration; e) the sodium, potassium and ammonium alkyl phosphates or phosphonates in which the alkyl group contains from about 10 to about 20 carbon atoms in either a linear or a branched configuration; and f) the sodium, potassium and ammonium alkyl carboxylates in which the alkyl group contains from about 10 to about 20 carbon atoms in either a linear or a branched configuration, and combinations thereof. Especially preferred for the practice of the present invention are surfactant systems containing C₁₀-C₂₀ linear alkyl benzene sulphonates (LAS) and C₁₀-C₂₀ linear or branched unalkoxylated alkyl sulfates (AS).

Preferred for the practice of the present invention are LAS surfactants, as described hereinabove. The LAS can be present in either the pre-treatment composition or the subsequently added fabric treatment composition in an amount sufficient to form an aqueous wash liquor containing from about 100 ppm to about 2000 ppm, preferably from about 200 ppm to about 1500 ppm, more preferably from about 300 ppm to about 1000 ppm, of LAS.

The pre-treatment composition or the subsequently added fabric treatment composition may comprise (either as an alternative to LAS or in combination with LAS) one or more AS surfactants, as described hereinabove. The AS surfactant(s) can be present in the pre-treatment composition or the subsequently added fabric treatment composition in an amount sufficient to form an aqueous wash liquor containing from 0 ppm to about 2000 ppm, preferably from 0 ppm to about 1500 ppm, more preferably from 0 ppm to about 1000 ppm, of AS.

The pre-treatment composition or the subsequently added fabric treatment composition may further comprise one or more C₁₀-C₂₀ linear or branched alkylalkoxylated sulfates (AAS) having an average degree of alkoxylation ranging from about 0.1 to about 5, preferably from about 0.3 to about 4 and more preferably from about 0.5 to about 3. Such AAS surfactants can be present therein at an amount sufficient to form an aqueous wash liquor containing from about 100 ppm to about 2000 ppm, preferably from about 200 ppm to about 1500 ppm, more preferably from about 250 ppm to about 500 ppm, of AAS.

Further, the pre-treatment composition or the subsequently added fabric treatment composition may contain one or more nonionic surfactant in an amount sufficient to form an aqueous wash liquor containing from 50 ppm to about 1000 ppm, preferably from 100 ppm to about 750 ppm, more preferably from 150 ppm to about 500 ppm, of said nonionic surfactant. Preferred nonionic surfactants are those of the formula R¹(OC₂H₄)ₙOH, wherein R¹ is a C₁₀-C₂₀ alkyl group or alkyl phenyl group, and n is from about 1 to about 80. Particularly preferred are C₁₀-C₂₀ alkylalkoxylated alcohols (AA) having an average degree of alkoxylation from 1 to 20.

Other surfactants useful herein include amphoteric surfactants and cationic surfactants. Such surfactants are well known for use in laundry detergents and can be included in the pre-treatment composition or the subsequently added fabric treatment composition of the present invention in a sufficient amount to form an aqueous wash liquor containing present at levels from 0 ppm to about 300 ppm, preferably from 0 ppm to about 200 ppm, more preferably from 0 ppm to about 100 ppm, of such amphoteric and/or cationic surfactants.

The pre-treatment composition or the subsequently added fabric treatment composition may also contain one or more adjunct ingredients commonly used for formulating liquid laundry detergent compositions, such as fillers, carriers, structurants or thickeners, clay soil removal/anti-redeposition agents, polymeric soil release agents, polymeric dispersing agents, polymeric grease cleaning agents, enzymes, enzyme stabilizing systems, amines, bleaching compounds, bleaching agents, bleach activators, bleach catalysts, brighteners, dyes, hueing agents, dye transfer inhibiting agents, chelating agents, softeners or conditioners (such as cationic polymers or silicones), perfumes (including perfume encapsulates), hygiene and malodor treatment agents, and the like.

The automatic pre-treatment of water can be readily achieved by installing an inline mixer or any other suitable mixing device in the automatic washing machine to dose the pre-treatment composition into the water supply going into the machine. For example, slow and continuous injection of the pre-treatment composition can be achieved by using an injector, which dispenses the pre-treatment composition into the water line to pre-treat at least the volume of water required for substantially wetting the fabrics. The washing machine plugs into the injector box, which then connects to a power socket. The injector box also has a power meter integrated, so that it reads the power consumption of the washing machine during the wash cycle. When the water starts flowing, a water flowmeter monitors the incoming water flowrate, while a ratio controller simultaneously controls the flowrate of the injected pre-treatment composition into the water pipe so that it is at a fixed ratio to the incoming water flowrate. The ratio controller ensures that irrespective of the amount of water flowing into the washing machine (which is typically determined based on the type and amount of fabrics inside the washing machine), the concentration of the pre-treatment composition in the water remains constant.

Preferably, the mixing device is configured to ensure that only pre-treated water comes in contact with the unwetted fabrics in the automatic washing machine until the fabrics become substantially wetted by the pre-treated water. In other words, little or no un-treated water is allowed to contact the unwetted fabrics until such fabrics are substantially wetted by or saturated with the pre-treated water. Once such fabrics are fully or substantially wetted by the pre-treated water, additional un-treated water may be supplied to the automatic washing machine to fill the full volume. Typically, the pre-treated water is at least 50%, preferably at least 70%, more preferably at least 90%, most preferably 100% by total volume of water used by said automatic laundry washing machine for treating said fabrics during one wash cycle.

### EXAMPLES

### Example 1

### Stain Removal Performance of Fabric Treatment Process Conducted With and Without Pre-Treatment of Water by Chelants

The experiment is conducted in a mid-scale mini-washer consisting of 5 vessels with an 8 L capacity, with a central spindle agitator which operates in parallel. Filling, agitation, rinses and spins are manually operated. Cleaning of the vessels and spindles is carried out before use with the Fairy washing-up liquid followed by multiple rinses with hot water (40° C.), agitated for two minutes and then spun out until all residual washing up liquid has been rinsed away. City water (8.3 US gpg) at a target wash temperature (30° C.) is used to fill each vessel with 8 L of water. A

Heavy Metal Ion (HMI) spike containing metal ions as listed hereinafter in Table 1 is then added to each vessel, and mini-washers are turned on to agitate for 10-20 seconds to fully disperse the HMI.

TABLE 1

| Heavy Metal Ion | Complex Added | ppm |
|---|---|---|
| Fe | FeCl₃ 6H₂0 | 2.1 |
| Zn | ZnCl₂ | 2.3 |
| Cu | CuCl₂ 2H₂0 | 1.1 |
| Mn | MnCl₂ 4H₂0 | 0.2 |

In an inventive fabric treatment process according to the present invention, an inventive pre-treatment composition containing two chelants HEDP and DTPMP at a weight ratio of about 1:1 is added to the mini-washers and agitated for 20 seconds to fully disperse the chelants. Subsequently, a ballast comprising 400 g of terry towel swatches (30×20 cm) and fabrics containing tea, wine and coffee stains to be analyzed are added to each of the vessels. The mini-washers are then turned on to agitate and thoroughly wet the stain-containing fabrics and the ballast for 30 seconds. Subsequently, an inventive fabric treatment composition containing all the ingredients used in a full laundry detergent composition except the chelants (i.e., the fabric treatment composition equals a full detergent formulation minus HEDP and DTPMP) is then added to each vessel, and the agitation is immediately restarted to wash for 12 minutes at 47 rpm, followed by a 2-minute spin cycle. The ballast and the stain-containing fabrics are then removed, and the mini-washers are refilled with 8 L of 15° C. rinse water. The ballast and the stain-containing fabrics are returned to the mini-washer and are agitated for 2 minutes at 47 rpm, followed by a 2-minute spin. Afterwards, the ballast and the stain-containing fabrics are dried on a cotton extra dry cycle in Miele Novotronic T430 electric dryer. The extent of stain removal is calculated as the color difference between the stain and the textile's background before and after wash (see Error! Reference source not found.).

The initial color difference is defined as initial noticeability (ABᵢ, Equation 1), whereas the final noticeability (ADᵢ, Equation 2) refers to the color difference between the stains and the textiles' background after the wash. The Stain Removal Index (SRIᵢ) for a given stain i is calculated as described by Equation 3.

$$\begin{matrix}{AB}_{i} = \sqrt{{( {L}_{{s}_{io}} - {L}_{{b}_{o}} )}^{2} + {( {a}_{{s}_{io}} - {a}_{{b}_{o}} )}^{2} + {( {b}_{{si}_{o}} - {b}_{{b}_{o}} )}^{2}} & Equation 1 \\ {AD}_{i} = \sqrt{{( {L}_{{s}_{if}} - {L}_{{b}_{o}} )}^{2} + {( {a}_{{s}_{{i}_{f}}} - {a}_{{b}_{o}} )}^{2} + {( {b}_{{s}_{if}} - {b}_{{b}_{bo}} )}^{2}} & Equation 2 \\ {SRI}_{i} ( \% ) = \frac{{IN}_{i} - {FN}_{i}}{{IN}_{i}} \cdot 100 & Equation 3\end{matrix}$$

Where Lₛ_{ᵢₒ}, aₛ_{ᵢₒ}, bₛ_{ᵢₒ} and Lₛ_{_{if}}, aₛ_{_{if}}, bᵢₛ_{_{if}} are the initial and final color coordinates of a given stain i in the L*a*b* color space respectively and L_{b}_{ₒ}, a_{b}_{ₒ}, b_{b}_{ₒ} are the initial color coordinates of the textiles' background (L*a*b* color space).

In a comparative fabric treatment process, all of the above-described steps are carried out, except that no pre-treatment composition containing the chelants is added to the mini-washers before the ballast and the stain-containing fabrics are added to each of the vessels. Instead, a comparative fabric treatment composition containing all the ingredients used in a full laundry detergent composition, including the chelants (i.e., the fabric treatment composition equals the full detergent formulation), is subsequently added.

Table 2 below lists respective formulations of the above-mentioned inventive pre-treatment composition, the inventive fabric treatment composition, and the comparative fabric treatment composition (as concentrations of ingredients in the aqueous wash liquor formed thereby):

TABLE 2

| | | Inventive | Inventive | Comparative |
|---|---|---|---|---|
| | | Pre- | Fabric | Fabric |
| | | Treatment | Treatment | Treatment |
| | | Composition | Composition | Composition |
| | Ingredients | (ppm) | (ppm) | (ppm) |
| Surfactants | LAS | — | 298.9 | 298.9 |
| | C14-15 AA | — | 245.9 | 245.9 |
| | with 7 EO | | | |
| | C12-14 AES | — | 219.9 | 219.9 |
| | with 3 EO | | | |
| | (70%) | | | |
| Builders/ | Fatty Acids | — | 121.0 | 121.0 |
| Chelant | Citric Acid | — | 75.2 | 75.2 |
| | (50%) | | | |
| | Ionic strength | — | 155.6 | 155.6 |
| | premix (citric | | | |
| | acid) | | | |
| | DTPMP | 25 | — | 25 |
| | HEDP | 25 | — | 25 |
| Performance | Zwitterionic | — | 24.5 | 24.5 |
| actives/ | hexamethylene | | | |
| preservatives | diamine | | | |
| | Polyethylene | — | 50.5 | 50.5 |
| | glycol (PEG)- | | | |
| | co-polyvinyl | | | |
| | acetate (PvAc) | | | |
| | Brightener | — | 3.9 | 3.9 |
| | Preservative | — | 0.2 | 0.2 |
| Enzymes/ | Protease | — | 1.61 | 1.61 |
| stabilisers | Amylase | — | 0.20 | 0.20 |
| | Mannanase | — | 0.16 | 0.16 |
| | Pectawash | — | 0.087 | 0.087 |
| | CaCl2 solution | — | 0.3 | 0.3 |
| | Na Formate | — | 8.6 | 8.6 |
| | 40% solution | | | |
| Solvent/ | Ethanol | — | 19.5 | 19.5 |
| neutralizer/ | 1,2 Propylene | — | 124.9 | 124.9 |
| structural | glycol | | | |
| | NaCS | — | 52.1 | 52.1 |
| | NaOH | — | 103.6 | 103.6 |
| | Hydrogenated | — | 15.1 | 15.1 |
| | castor oil | | | |
| Antifoam | Silicone | — | 0.105 | 0.105 |
| | emulsion | | | |

The following Table 3 shows the stain removal performance of the inventive fabric treatment process in comparison with that of the comparative fabric treatment process against various tough stains:

TABLE 3

| | | SRI of Inventive Process |
|---|---|---|
| | SRI of Comparative | Minus That of Comparative |
| | Process | Process (ΔSRI) |
| Coffee stain¹ | 59.5 | 2.4* |
| Tea stain² | 24.5 | 8.3* |
| Wine stain³ | 47.5 | 7.4* |

*The difference is statistically significant
¹Expresso coffee EQ195
²GSRTLIT001 GMT Tea sourced from Warwick Equest Ltd. (Durham, UK)
³GSRTRW001 GMT Red Wine sourced from Warwick Equest Ltd. (Durham, UK)

The above stain removal performance results demonstrate that the inventive fabric treatment process (when the entire water volume is pre-treated with chelants before coming into contact with the stain-containing fabrics) shows statistically significant improvement in the stain removal benefit over the comparative fabric treatment process (when the stain-containing fabrics are contacted with un-treated water, followed by addition of chelants and other detersive actives).

### Example 2

### Stain Removal Performance of Fabric Treatment Process Conducted With and Without Pre-Treatment of Water by Chelants and Builders

The experiment is conducted in a mid-scale high-throughput equipment that runs on a Peerless Systems platform. It consists of 10 vessels of 1 L capacity with a three-blade post agitator similar to the one used by Ganguli and Eenderbug (1980), which operates in parallel. The equipment is automatized so that filling, washing, draining and rinsing of the vessels is automatically conducted by the system.

Initially, cleaning of the vessels is conducted prior to starting the wash process by adding 0.25 L of city water (˜10 gpg) at the target washing temperature (30° C.) to each of the vessels of the equipment. The water remains in the vessels for 2 minutes under a constant agitation of 1800 deg/s. After draining the water used for the cleaning stage, 0.8 L of city water at the target washing temperature (30° C.) is added to each of the vessels.

In an inventive fabric treatment process according to the present invention, after the addition of 0.8 L of city water at 30° C. to each of the vessels, an inventive pre-treatment composition containing chelants (HEDP and DTPMP at a weight ratio of about 1:1) and builders (fatty acids and citric acids) is pre-dissolved in 0.02 L of water and then manually added to each of the vessels where it is mixed with the rest of the water for 2 minutes at 1800 deg/s. Afterwards, a ballast comprising 50 g of knitted cotton swatches (5 cm×5 cm) and a load of stain-containing fabrics including 10 g of 7 cm×7 cm knitted cotton swatches are added to each of the vessels, and the agitation is immediately re-started afterwards at 1800 deg/s for 2 additional minutes. Next, an inventive fabric treatment composition containing all ingredients of a full laundry detergent composition except the chelants and builders is pre-dissolved in 0.18 L of water and then manually added to each of the vessels, and the wash process is started. In this inventive fabric treatment process, the entire volume of water used for the wash process is pre-treated with chelants and builders before the stain-containing fabrics come in contact with any water.

In a comparative fabric treatment process, after the addition of 0.8 L of city water at 30° C. to each of the vessels, a ballast comprising 50 g of knitted cotton swatches (5 cm×5 cm) and a load of stain-containing fabrics including 10 g of 7 cm×7 cm knitted cotton swatches are manually added to each of the vessels where they remain in contact with the water under a constant agitation of 1800 deg/s for 2 min. Next, a comparative fabric treatment composition containing all ingredients of a full laundry detergent composition, including the chelants and builders, is pre-dissolved in 0.2 L of water and then manually added to each of the vessels, and the wash cycle is started.

Table 4 below lists respective formulations of the above-mentioned inventive pre-treatment composition, the inventive fabric treatment composition, and the comparative fabric treatment composition (as concentrations of ingredients in the aqueous wash liquor formed thereby):

TABLE 4

| | | Inventive | Inventive | Comparative |
|---|---|---|---|---|
| | | Pre- | Fabric | Fabric |
| | | Treatment | Treatment | Treatment |
| | | Composition | Composition | Composition |
| | Ingredients | (ppm) | (ppm) | (ppm) |
| Surfactants | LAS | — | 367.94 | 367.94 |
| | C14-15 AA | — | 188.03 | 188.03 |
| | with 7 E0 | | | |
| | C12-14 AES | — | 284.18 | 284.18 |
| | with 3 EO | | | |
| | (70%) | | | |
| | C12-C14 amine | — | 28.63 | 28.63 |
| | oxide | | | |
| Builders/ | Fatty Acids | 86.33 | — | 86.33 |
| Chelant | Citric Acid | 108.62 | — | 108.62 |
| | (50%) | | | |
| | DTPMP | 25 | — | 25 |
| | HEDP | 25 | — | 25 |
| Performance | Zwitterionic | — | 29.74 | 29.74 |
| actives/ | hexamethylene | | | |
| preservatives | diamine | | | |
| | Polyethylene | — | 43.88 | 43.88 |
| | glycol (PEG)- | | | |
| | co-polyvinyl | | | |
| | acetate (PvAc) | | | |

In both the inventive and comparative fabric treatment processes, the main wash is conducted at a constant pH=8 for 30 minutes at 30° C. under a constant agitation of 1800 deg/s, followed by a 15-minute rinse cycle at pH=8, keeping the wash liquor temperature at 30° C. and a constant agitation of 1800 deg/s. Once the washing cycle is finished, the fabric swatches are removed from each of the vessels and introduced in individual drying bags. Afterwards, the fabrics are dried for 45 minutes at low temperature in an Electrolux T3290 gas dryer. Stain removal index (SRI) is calculated as the color difference between the stains and the textile's background before and after wash.

The following Table 5 shows the stain removal performance of the inventive fabric treatment process in comparison with that of the comparative fabric treatment process against tea and wine stains:

TABLE 5

| | | SRI of Inventive process |
|---|---|---|
| | SRI of Comparative | minus that of Comparative |
| | Process | Process (ΔSRI) |
| Tea stain¹ | 30.0 | 9.58* |
| Wine stain² | 73.2 | 7.42* |

*The difference is statistically significant
¹GSRTLIT001 GMT Tea sourced from Warwick Equest Ltd. (Durham, UK)
²GSRTRW001 GMT Red Wine sourced from Warwick Equest Ltd. (Durham, UK)

The above stain removal performance results demonstrate that the inventive fabric treatment process (when the entire water volume is pre-treated with chelants and builders before coming into contact with the stain-containing fabrics) shows statistically significant improvement in the stain removal benefit over the comparative fabric treatment process (when the stain-containing fabrics are contacted with un-treated water, followed by addition of chelants, builders and other detersive actives).

### Example 3

### Stain Removal Performance of Fabric Treatment Process Conducted With and Without Pre-Treatment of Water by Full Laundry Detergent Composition

Similar to Example 2, this experiment is also conducted in a mid-scale high-throughput equipment that runs on a Peerless Systems platform. Filling, washing, draining and rinsing of the vessels is automatically conducted by the system.

Initially, cleaning of the vessels is conducted prior to starting the wash process by adding 0.25 L of city water (˜10 gpg) at the target washing temperature (30° C.) to each of the vessels of the equipment. The water remains in the vessels for 2 minutes under a constant agitation of 1800 deg/s. After draining the water used for the cleaning stage, 0.8 L of city water at the target washing temperature (30° C.) is added to each of the vessels.

In an inventive fabric treatment process according to the present invention, after the addition of 0.8 L of city water at 30° C. to each of the vessels, an inventive pre-treatment composition containing all the ingredients of a full laundry detergent composition is pre-dissolved in 0.2 L of water and then manually added to each of the vessels where it is mixed with the rest of the water for 2 minutes at 1800 deg/s. Afterwards, a ballast comprising 50 g of knitted cotton swatches (5 cm×5 cm) and a load of stain-containing fabrics including 10 g of 7 cm×7 cm knitted cotton swatches are added to each of the vessels, and the agitation is immediately re-started afterwards at 1800 deg/s for 2 additional minutes prior to starting of the wash cycle. In this inventive fabric treatment process, the entire volume of water used for the wash process is pre-treated with a full laundry detergent composition before the stain-containing fabrics come in contact with any water.

In a comparative fabric treatment process, after the addition of 0.8 L of city water at 30° C. to each of the vessels, a ballast comprising 50 g of knitted cotton swatches (5 cm×5 cm) and a load of stain-containing fabrics including 10 g of 7 cm×7 cm knitted cotton swatches are manually added to each of the vessels where they remain in contact with the water under a constant agitation of 1800 deg/s for 2 min. Next, a comparative fabric treatment composition containing all ingredients of a full laundry detergent composition is pre-dissolved in 0.2 L of water and then manually added to each of the vessels, and the wash cycle is started.

Table 6 below lists respective formulations of the above-mentioned inventive pre-treatment composition and the comparative fabric treatment composition (as concentrations of ingredients in the aqueous wash liquor formed thereby):

TABLE 6

| | | Inventive | Comparative |
|---|---|---|---|
| | | Pre- | Fabric |
| | | Treatment | Treatment |
| | | Composition | Composition |
| | Ingredients | (ppm) | (ppm) |
| Surfactants | LAS | 367.94 | 367.94 |
| | C14-15 AA with 7 EO | 188.03 | 188.03 |
| | C12-14 AES with 3 EO | 284.18 | 284.18 |
| | (70%) | | |
| | C12-C14 amine oxide | 28.63 | 28.63 |
| Builders/ | Fatty Acids | 86.33 | 86.33 |
| Chelant | Citric Acid (50%) | 108.62 | 108.62 |
| | DTPMP | 50 | 50 |
| Performance | Zwitterionic | 29.74 | 29.74 |
| actives/ | hexamethylene | | |
| preservatives | diamine | | |
| | Polyethylene glycol | 43.88 | 43.88 |
| | (PEG)-co-polyvinyl | | |
| | acetate (PvAc) | | |

In both the inventive and comparative fabric treatment processes, the main wash is conducted at a constant pH=8 for 30 minutes at 30° C. under a constant agitation of 1800 deg/s, followed by a 15-minute rinse cycle at pH=8, keeping the wash liquor temperature at 30° C. and a constant agitation of 1800 deg/s. Once the washing cycle is finished, the fabric swatches are removed from each of the vessels and introduced in individual drying bags. Afterwards, the fabrics are dried for 45 minutes at low temperature in an Electrolux T3290 gas dryer. Stain removal index (SRI) is calculated as the color difference between the stains and the textile's background before and after wash.

The following Table 7 shows the stain removal performance of the inventive fabric treatment process in comparison with that of the comparative fabric treatment process against various stains:

TABLE 7

| | | SRI of Inventive process |
|---|---|---|
| | SRI of Comparative | minus that of Comparative |
| | Process | Process (ΔSRI) |
| Sebum stain¹ | 44.6 | 6.2* |
| Tea stain² | 31.3 | 14.6* |
| Wine stain³ | 68.5 | 7.9* |
| Make-up stain⁴ | 31.3 | 5.2* |

*The difference is statistically significant
¹C-S-94 ASTM Dust Sebum supplied by Center for Testmaterials B.V. (Vlaardingen, The Netherlands)
²GSRTLIT001 GMT Tea sourced from Warwick Equest Ltd. (Durham, UK)
³GSRTRW001 GMT Red Wine sourced from Warwick Equest Ltd. (Durham, UK)
⁴GSRTCGM001 GMT Makeup sourced from Warwick Equest Ltd. (Durham, UK)

The above stain removal performance results demonstrate that the inventive fabric treatment process (when the entire water volume is pre-treated with a full laundry detergent composition before coming into contact with the stain-containing fabrics) shows statistically significant improvement in the stain removal benefit over the comparative fabric treatment process (when the stain-containing fabrics are contacted with un-treated water, followed by addition of full laundry detergent composition).

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of treating fabrics using an automatic laundry washing machine, comprising the steps of:
a) Providing a pre-treatment composition comprising at least one chelant and an automatic laundry washing machine capable of automatically pre-treating water with said pre-treatment composition;
b) Operating said automatic laundry washing machine to automatically pre-treat water with said pre-treatment composition;
c) Subsequently, contacting unwetted fabrics with a sufficient amount of the pre-treated water in said automatic laundry washing machine to substantially wet said fabrics; and
d) Subsequently, treating the wetted fabrics in said automatic laundry washing machine.

2. The method of claim 1, wherein the automatic laundry washing machine comprises an inline mixer for automatic pre-treatment of water; and wherein preferably the automatic laundry washing machine further comprises a water flowmeter for monitoring the incoming water flowrate and a ratio controller for simultaneously controlling the flowrate of the injected pre-treatment composition into the water pipe so that it is at a fixed ratio to the incoming water flowrate.

3. The method of claim 1, wherein said at least one chelant is selected from the group consisting of hydroxyethylidene diphosphonic acid (HEDP) and salts thereof, diethylene triamine penta(methylenephosphonic) acid (DTPMP) and salts thereof, ethylene diamine tetra(methylenephosphonic) acid (DDTMP) and salts thereof, amino tris(methylenephosphonic) acid (ATMP) and salts thereof, nitrilo tetra(methylenephosphonic) acid (NTMP) and salts thereof, ethylene diamine tetra(methylenephosphonic) acid (EDTMP) and salts thereof, tetraethylene diamine tetra(methylenephosphonic) acid (TDTMP) and salts thereof, hexamethylene diamine tetra(methylenephosphonic) acid (HDTMP) and salts thereof, diethylene triamine pentaacetic acid (DTPA) and salts thereof, ethylene diamine tetraacetic acid (EDTA) and salts thereof, hydroxyethylethylene diamine triacetic acid (HEDTA) and salts thereof, ethylene diamine disuccinic acid (EDDS) and salts thereof, disulfonated catechol, methylglycine diacetic acid (MGDA) and salts thereof, hydroxyiminodisuccinic acid (HIDS) and salts thereof, L-glutamic acid N,N-diacetic acid (GLDA) and salts thereof, and any combinations thereof.

4. The method according to claim 1, wherein said pre-treatment composition further comprises at least one builder; wherein said at least one builder is selected from the group consisting of fatty acids and salts thereof, citric acid and salts thereof, boric acid and salts thereof, zeolite, and any combinations thereof.

5. The method according to claim 1, wherein said pre-treatment composition further comprises at least one detersive surfactant.

6. The method according to claim 1, wherein said pre-treatment composition is essentially free of any detersive surfactants, and wherein a fabric treatment composition comprising at least one detersive surfactant is subsequently added into the aqueous wash liquor after step (c) for treatment of the wetted fabrics.

7. The method according to claim 1, wherein the pre-treated water is at least 50% by total volume of water used by said automatic laundry washing machine for treating said fabrics during one wash cycle.

8. The method according to claim 1, wherein the fabrics to be treated comprise one or more stains selected from the group consisting of tea stains, wine stains, coffee stains, body soils, greasy stains, and any combinations thereof.
